(19) United States
(12) Patent Application Publication
(10) Pub. No.: US 2012/0286621 A1
(43) Pub. Date: Nov. 15, 2012

(54) Lamination For Stator Core, Stator Core Comprising Said Lamination and Method For Making Said Lamination

(75) Inventor: Lino Soga, Montecchio Maggiore (VI) (IT)

(73) Assignee: Enrico Soga, Montecchio Maggiore (IT)

(21) Appl. No.: 13/469,879

(22) Filed: May 11, 2012

(30) Foreign Application Priority Data
May 12, 2011 (IT) VI2011A000121

(51) Int. Cl. H02K 1/16

(52) U.S. Cl. 310/216.008

(57) ABSTRACT

Modular element (1; 15) for a stator core (8; 18), comprising a plate-like body (7) in a ferromagnetic material provided with: a peripheral portion (2) extending for an angular width (α) of less than 360° along an arc of a circle with centre (X1); teeth (3; 16) projecting from the peripheral portion (2) towards the centre (X1); first projections (4, 4′) extending from the peripheral portion (2) towards the opposite side with respect to the teeth (3; 16), which are configured so that each one of them can be interposed between two corresponding adjacent teeth (3; 16) of a second modular element (1′; 15′) that is identical to the first one and arranged so that it is coplanar with it,

### FIELD OF THE INVENTION

The present invention concerns a lamination for a stator core, particularly suitable for making a stator core for multipole permanent magnet generators, in particular of the type used in wind-operated or hydraulic power generators, the latter being also known as “hydro generators” in technical jargon.

### BACKGROUND OF THE INVENTION

As is known, a permanent magnet generator comprises a cylindrical stator core provided with a longitudinal hole inside which the rotor is housed.

The stator core is comprised of a plurality of laminations made of a ferromagnetic material, stacked on one another according to the direction defined by the longitudinal axis of the stator core.

Each lamination features a substantially annular peripheral portion provided with a plurality of projections extending towards the longitudinal axis of the stator core, called “teeth” in technical jargon, around which the copper wire forming the stator windings is wound.

Each annular lamination can come in a single piece or be divided in modular elements, each one of which corresponds to a sector of the lamination, that are arranged adjacent to each other in order to form the lamination itself.

The external surface of the stator core is generally smooth and cylindrical in shape, so that it can be inserted inside a casing that serves also as a support for the generator.

The casing also serves as an element for dissipating the heat produced by the generator during operation and for this purpose it is provided with cooling fins that project from the surface of the casing.

It is known that, for various reasons, the weight of the generator must be as limited as possible, since a considerable weight means increased generator transport and installation costs.

Said costs are particularly high in the sector of electric energy production through wind turbines, in which the generator must be transported to places that are often difficult to reach, like for example hills, sea surfaces or deserts, and must be installed on the top of a supporting tower.

The weight of the generator also affects the cost of the above mentioned supporting tower, which must be sized in such a way as to support the weight of the generator as well as the weight of the wind turbine blades.

It must also be considered that, as the power of the wind turbine increases, the corresponding increase in the length of the turbine blades requires a higher tower.

The above makes it dear to understand that more wind turbine power means more drawbacks connected to the weight of the various components of the turbine and, consequently, a higher need to reduce this weight.

Furthermore, as the power of the wind turbine and therefore the blade length increase, the turbine rotation speed must be reduced in order to limit the peripheral speed of the blades themselves.

Consequently, in order to be able to deliver more power with lower rotation speed, the generator must be larger, which makes it even more important to limit the weight of the generator itself.

### BRIEF SUMMARY OF THE INVENTION

The present invention has the purpose of providing a multipole generator or, more generally, a power generator or an electrical machine whose overall weight is lower than the weight of equivalent electrical machines of the known type.

It is another object of the invention to reduce the quantity of material used for the construction of the above mentioned generator.

The above mentioned object is achieved by a modular element for making a lamination for stator core produced according to claim 1, as well as by a stator core comprising said modular element, according to claim 7, and by a method for making said modular element, according to claim 15.

Further characteristics and details of the invention are described in the corresponding dependent claims.

Advantageously, the lamination obtained with the invention makes it possible to obtain a stator core and thus a power generator or an electrical machine weighing less than an equivalent machine of the known type, in particular with multipole generators of the type used in the sector of production of wind power or hydro power.

Still advantageously, the above mentioned weight reduction makes it possible to limit also the weight of the bearing structure intended to support the machine itself, in particular in the case where the electrical machine is a generator for wind turbines.

In the case just mentioned, said weight reduction also makes it possible to reduce the overall installation cost of the wind turbine using said generator.

### BRIEF DESCRIPTION OF THE DRAWINGS

The above mentioned objects and advantages, together with others which will be highlighted below, are illustrated in the description of two preferred embodiments of the invention which are provided by way of non-limiting examples with reference to the attached drawings, wherein:

FIG. 1 shows a plan view of a modular element for a stator core according to the invention;

FIG. 2 shows a plan view of the arrangement of two modular elements according to FIG. 1 during the strip shearing operation;

FIG. 3 shows an axonometric view of some modular elements according to FIG. 1 during the assembly of a stator core according to the invention;

FIG. 4 shows an axonometric view of a stator core produced using the modular elements shown in FIG. 1;

FIG. 5 shows a plan view of a variant embodiment of a modular element according to the invention;

FIG. 6 shows a plan view of the arrangement of two modular elements according to FIG. 5 during the strip shearing operation;

FIG. 7 shows an axonometric view of a stator core produced using the modular elements shown in FIG. 5;

FIG. 8 shows an enlarged view of the detail VIII of FIG. 7.

### DETAILED DESCRIPTION OF THE INVENTION

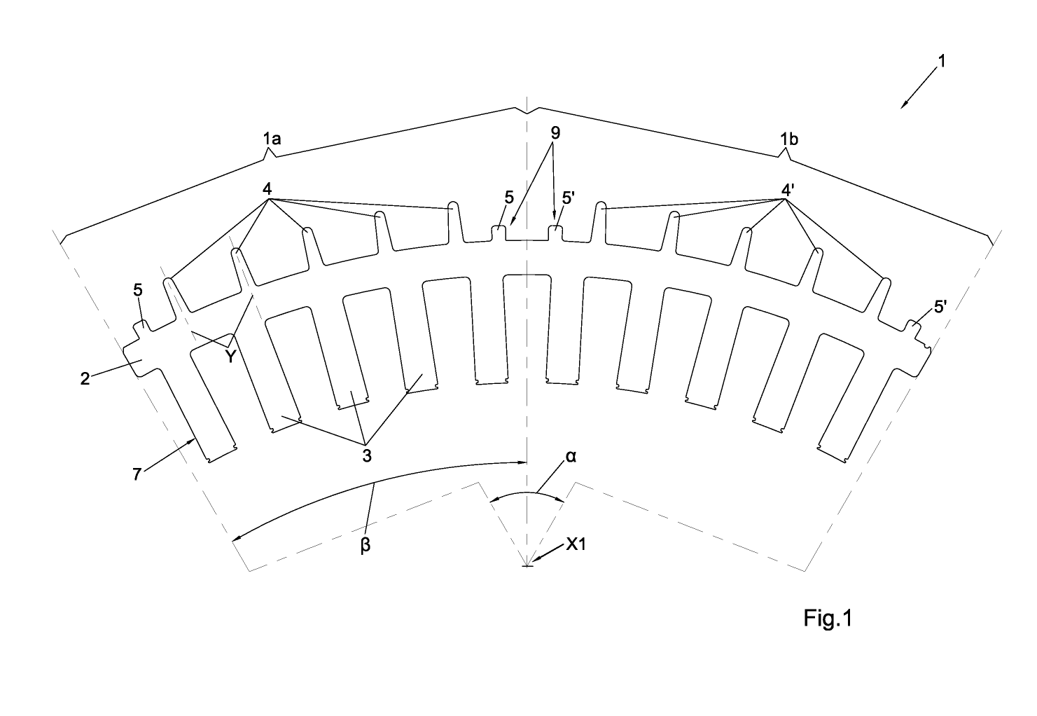

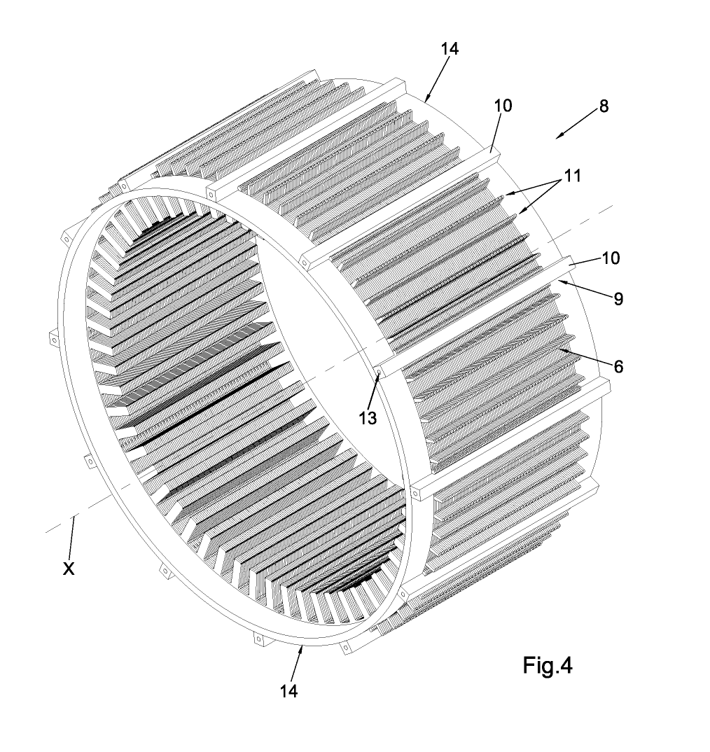

The modular element of the invention, indicated by the reference number 1 in FIG. 1, is particularly suitable for making a multipole stator core 8 for a permanent magnet generator of the type used for the generation of wind or hydro power shown in FIG. 4.

It will be clear to the person skilled in the art that the concept on which the invention is based can be applied in an analogous manner to make a stator core suitable for any type of power generator or electrical machine.

As can be seen in FIG. 4, the stator core 8 of the invention comprises a plurality of laminations 6 stacked on each other along the direction of the longitudinal axis X of the stator core 8.

Each lamination 6 comprises a plurality of modular elements 1, one of which is shown in FIG. 1, arranged adjacent to one another so as to form a ring.

Advantageously, the division of the laminations 6 in modular elements corresponding to different sectors of each lamination makes it possible to reduce the quantity of material used for the production of the laminations themselves, as is clearly explained here below.

Each modular element 1 comprises a corresponding plate-like body 7 in a ferromagnetic material, which is constituted by a peripheral portion 2 to extending in a substantially annular shape over a predefined angular width α around a centre X1 belonging to the longitudinal axis X of the stator core 8.

The modular element 1 also comprises a plurality of teeth 3 projecting from the peripheral portion 2 towards the above mentioned centre X1, around which the copper wire making up the windings of the stator core 8 is wound.

The modular element 1 also comprises a plurality of first projections 4, 4 that extend from the peripheral portion 2 on the opposite side with respect to the teeth 3 according to corresponding directions of development Y that are preferably but not necessarily directed radially, meaning that they pass through the centre X1.

When the modular elements 1 are stacked to form the stator core 8, the alignment of the first projections 4, 4′ defines on the external surface of the stator core 8 the same number of fins 11 that preferably extend over the whole length of the stator core 8.

Clearly, the above mentioned fins 11 increase the external surface area of the stator core 8 and thus increase it capacity to dissipate heat.

Consequently, to advantage, for the above mentioned stator core 8 the presence of a finned casing is not required.

The absence of a finned casing makes it possible to achieve the object to reduce the weight of the stator core 8 compared to equivalent stator cores of the known type provided with casing.

Furthermore, to advantage, the absence of the casing simplifies the generator production process, thus reducing the cost of the latter.

Clearly, the heat dissipation capacity of the stator core 8 increases as the number of fins 11 increases.

Therefore, it is preferable for each modular element 1 to be provided with a large number of first projections 4, 4′, for example equal to or larger than the number of teeth 3 of the modular element 1.

For example, the modular element 1 of FIG. 1 is provided with an overall number of first projections 4, 4′ that is equal to the number of teeth 3.

The heat dissipation capacity of the stator core 8 also increases as the height of the fins 11 increases.

Therefore, the length of each projection 4, 4′, measured according to the corresponding direction of development Y, should be at least equal to and preferably exceed the average width of the projection itself, measured on the plane of the lamination 1 at right angles to the direction of development Y.

Due to analogous reasons related to the achievement of effective heat dissipation, it is also preferable that each projection 4, 4′ features gradually decreasing width along the corresponding direction of development Y as the distance from the centre X1 increases.

Preferably, and as anticipated above, the angular width α of the modular element 1 is equal to an integer submultiple of 360°.

In this way, each lamination 6 of the stator core 8 can be assembled by arranging side by side a number of modular elements 1 equal to the above mentioned integer submultiple, so as to form a closed ring.

Advantageously, the division of each annular lamination 6 in several modular elements 1 corresponding to an equivalent number of sectors of the lamination 6, makes it possible to reduce the scraps of the material used to make the lamination 6.

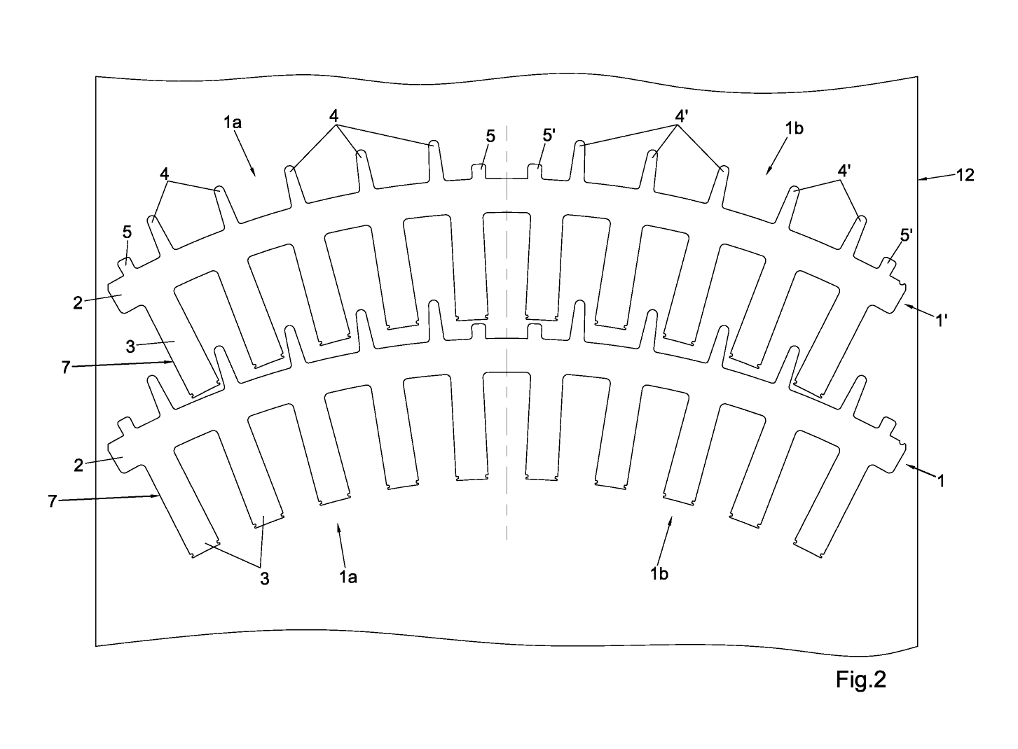

In fact, as shown in FIG. 2, each modular element 1 is a single piece obtained, typically, by shearing a continuous strip 12.

As clearly shown in the above mentioned FIG. 2, the modular elements 1, 1′ with an angular width of less than 360° can be arranged on the strip 12 so as to occupy a larger portion of the surface area of the strip itself, so as to reduce the amount of scraps.

By way of example, the modular elements 1 and 1′ of FIGS. 1 and 2 have an angular width α equal to 60° and, consequently, each lamination 6 is made by using 6 of the above mentioned modular elements 1, 1′.

It is also evident that in variant embodiments of the invention the angular width of the modular element 1 can be different from 60°.

As shown in FIG. 2, each modular element 1 is configured in such a way that it can be arranged coplanar with a second identical modular element 1′ so that each one of the first projections 4, 4′ comes to be interposed between two mutually adjacent teeth 3 of the second modular element 1′.

This is obtained by arranging the first projections 4, 4′ so that each one of them is spaced from each first projection 4, 4′ adjacent to it by a distance that cannot be shorter than the width of the end of a corresponding tooth 3.

In this way, each pair of first adjacent projections 4, 4′ delimits, together with the peripheral portion 2, corresponding intermediate cavities, each suited to house a corresponding tooth 3 of said second modular element 1′.

Therefore, to advantage, the above mentioned arrangement makes it possible to move the two modular elements 1, 1 near each other as much as possible along the strip 12, so as to use the material included between the teeth 3 of the second element 1′ to obtain the first projections 4, 4′ of the first modular element 1, consequently reducing the scraps.

Preferably, the distance between the first projections 4, 4′ substantially corresponds to the distance between the teeth 3.

In this case, the angular intervals between the first projections 4, 4′ are smaller than the angular intervals between the teeth 3, considering the is different radial positions of the two elements.

The plate-like body 7 is preferably provided with at least one first angular portion 1a that develops along the arc of a circle with a profile that is identical to the profile of a second angular portion 1b of the plate-like body 7 which, compared to the first angular portion 1a, is shifted of a predefined angular interval β around the centre X1.

The above mentioned configuration advantageously makes it possible to arrange two adjacent laminations 6 so that the corresponding modular elements 1 of two adjacent layers of the stator core 8 are mutually staggered around the longitudinal axis X of the stator core 8 of an angle equal to the above mentioned predefined angular interval β, at the same time maintaining the continuity of the fins 11 of the stator core 8.

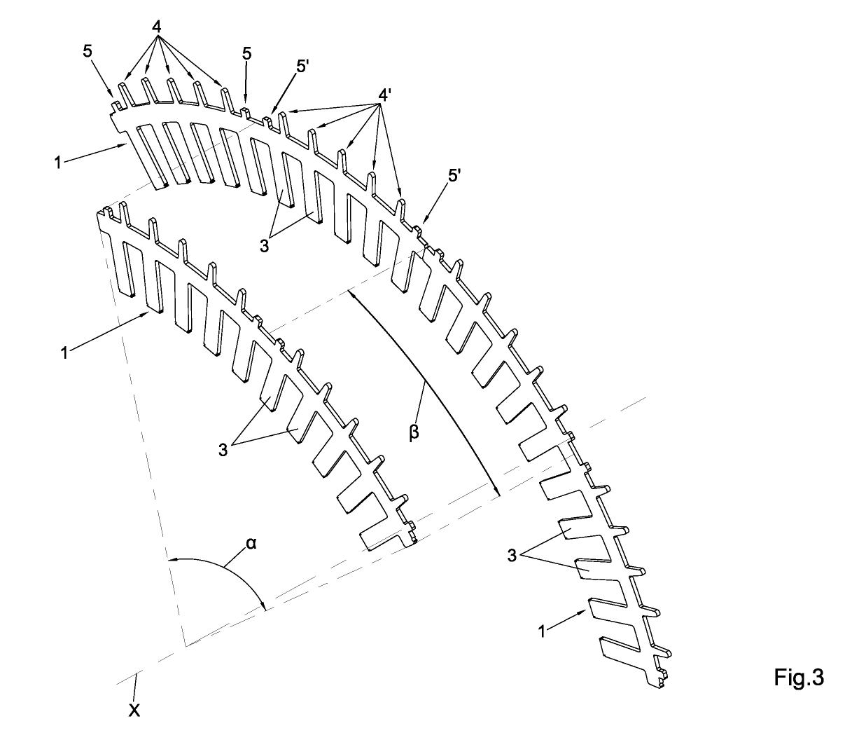

The above mentioned staggered arrangement is shown in FIG. 3, illustrating an exploded view of three identical modular elements 1 arranged in the assembly configuration of the stator core 8.

Considering the above mentioned modular elements 1, the front one belongs to a first lamination, while the two at the back belong to a second lamination that is staggered by the said angular interval β with respect to the first one.

Advantageously, the above mentioned staggered position makes it possible to increase the stiffness of the stator core 8.

Preferably, as shown in FIG. 1, the modular elements I are made so that each angular portion 1a and 1b is symmetrical with respect to a corresponding axis of symmetry that passes through the centre X1.

This symmetry makes it possible to make two modular elements face each other with any face, maintaining their ability to be superimposed as described above.

Furthermore, preferably, the first angular portion 1a and the second angular portion 1b extend each over a corresponding half of the overall angular width α of the modular element 1 and, therefore, the above mentioned angular interval β has the same amplitude.

This, advantageously, makes it possible to obtain a stator core 8 that is very stiff, as each modular element 1 overlaps half of a modular element of the adjacent lamination 6.

In particular, the first projections 4 belonging to the first angular portion 1a of the modular element I have the same shapes and mutual positions as the first projections 4′ belonging to the second angular portion 1b.

In this way, when the first angular portion 1a of a modular element 1 is superimposed to the second angular portion 1b of a second modular element, the first projections 4 of the first modular element 1 coincide precisely with the first projections 4′ of the second modular element.

As can be seen in FIG. 4, the laminations 6 are rigidly fixed to each other through joining means 9 that preferably but not necessarily comprise connection bodies 10, each one of which is welded to a plurality of modular elements 1.

In the example shown in the figure, the connection bodies 10 are 6 and are arranged on the external surface of the stator core 8 at regular intervals of 30°.

Obviously, variant embodiments of the invention may comprise connection bodies in a different number and with different shape and arrangement compared to those described above.

Preferably, the joining means 9 also comprise two second projections 5, 5′ belonging to each modular element I and projecting from the latter in such a way as to delimit a corresponding recess whose profile matches the profile of the cross section of the connection body 10.

Preferably, the second projections 5, 5′ are shorter than the first projections 4, 4′, so that they can be created in the centre area of the modular element 1 without causing any increase in the amount of scraps resulting from the shearing operation, as can be clearly inferred from FIG. 2.

In particular, the second projections 5, 5′ are preferably shorter than the distance between the peripheral portion 2 of a first modular element 1 and the end of the centre teeth of a second modular element 1′ arranged coplanar with the first one and with its side teeth in contact with the peripheral portion 2 of the first modular element 1.

Preferably, the second projections 5, 5′ are arranged symmetrically, analogously to the first projections 4, 4′ described above.

In particular, the second projections 5 belonging to the first angular portion 1 a of the modular element 1 have the same shapes and mutual to positions as the second projections 5′ belonging to the second angular portion 1b, so as to ensure that the two angular portions 1a and 1b can be precisely superimposed to each other.

According to a variant embodiment of the invention not illustrated herein, the connection bodies 10 can be positioned inside special channels in is the stator core 8, defined by aligning corresponding holes made in each lamination 6.

Advantageously, the connection of the laminations 6 obtained through the connection bodies 10 makes it possible to produce a self-bearing stator core 8, meaning a stator core that does not need to be inserted in a cylindrical casing to remain sound.

Consequently, to advantage, a generator obtained with the stator core 8 weighs less than equivalent generators of the known type, with the corresponding advantages already illustrated above.

Still advantageously, the absence of a casing simplifies the production process and thus reduces the production cost of the stator core.

Figures from 5 to 8 show a modular element 15 according to a variant embodiment of the invention, which differs from the modular element 1 described above for the different shape of the teeth 16, as well as the stator core 18 obtained with said modular element 15.

It is important to underline that, except where indicated otherwise, the reference numbers used in these figures to indicate the various elements are the same that are used to indicate the corresponding elements of the modular element 1 and of the stator core 8 previously described.

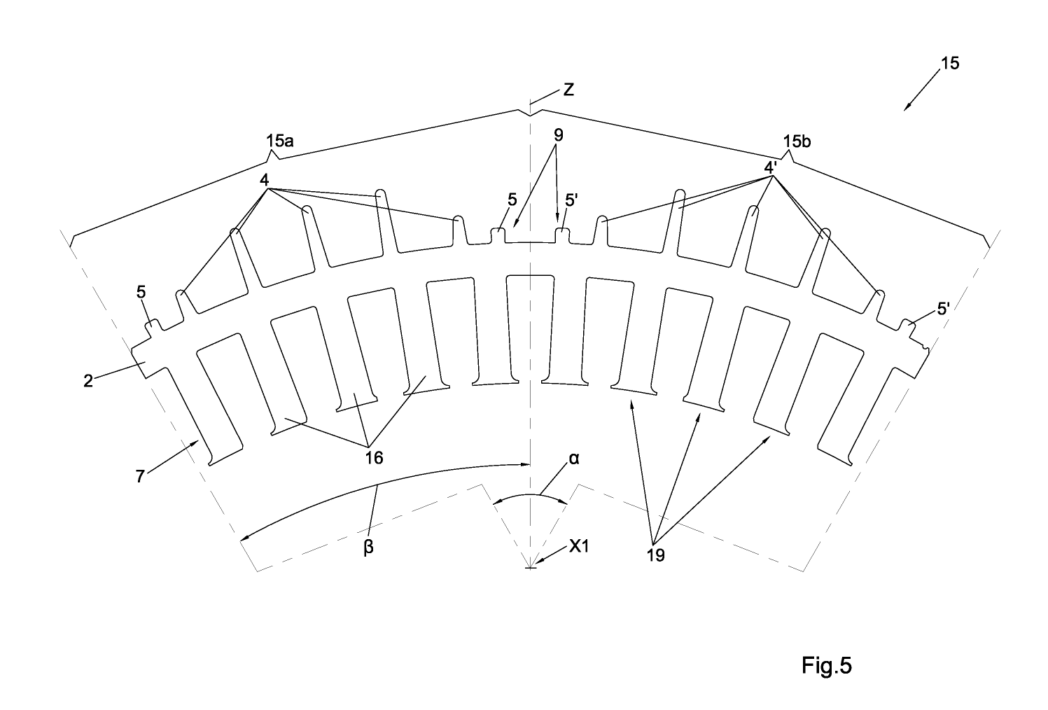

As shown in FIG. 5, each one of the teeth 16 of the modular element 15 comprises a widened end 19 that projects from at least one side of the tooth 16, in circumferential direction with respect to the centre X1 of the modular element 15, meaning in orthogonal direction with respect to the radius passing through the tooth 16.

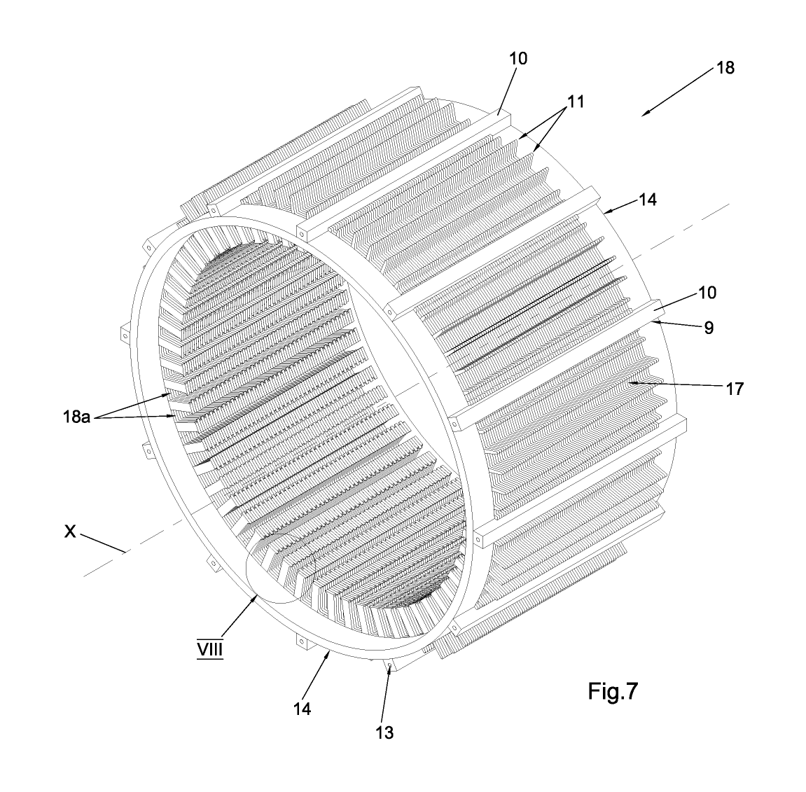

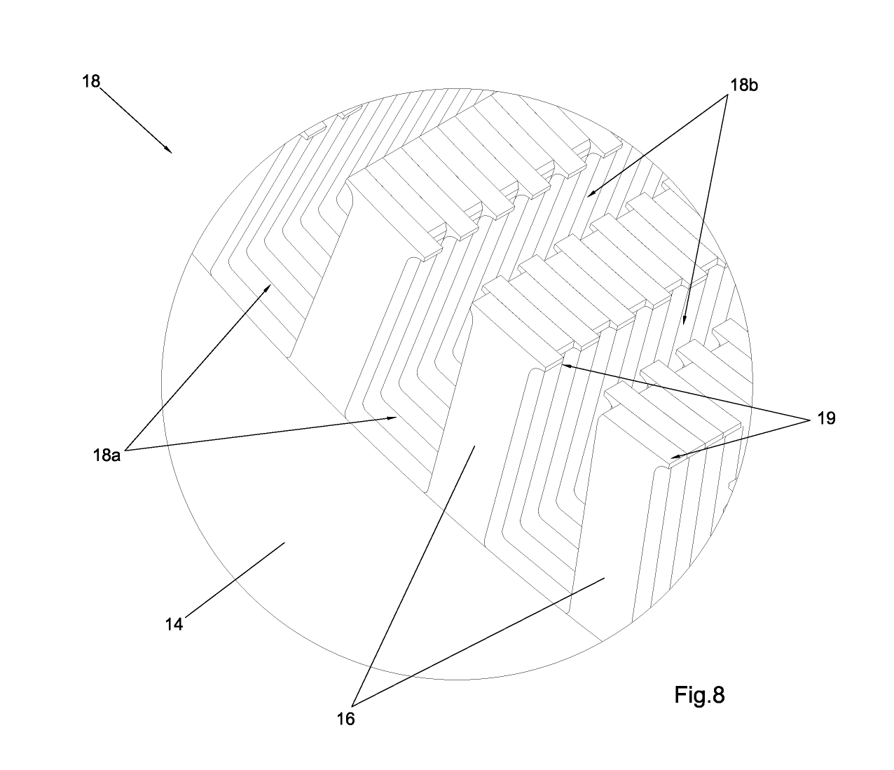

Advantageously, and as shown in FIGS. 7 and 8, the projections described above prevent the winding from slipping out of the recesses 18a once the stator core 18 has been assembled, especially in the case where the winding is made using a wire with circular cross section.

In fact, in this case, it is necessary to close the open area 18b of the recess 18a through an insulating foil, not illustrated herein but known per se, which is arranged inside the recess 18a and held in position by the projections described above.

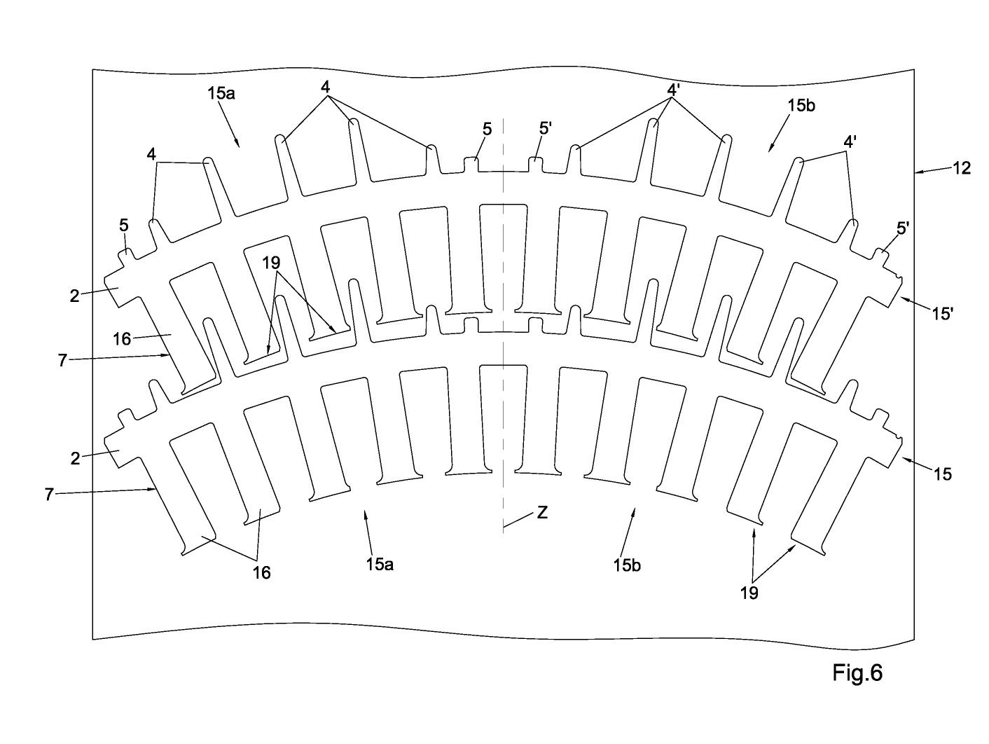

As shown in FIG. 6, the projections are short enough to leave, between the ends 19 of each pair of mutually adjacent teeth 16, a space that is at least as wide as the first projections 4, 4′.

In this way, the first projections 4, 4′ can be interposed between the teeth 16 of a second modular element 15′ that is identical to the first one and is arranged, with respect to the first modular element 15, in an analogous position with respect to the one described for the previous embodiment.

Consequently, all the advantages already mentioned above for the previous embodiment are maintained.

Furthermore, as shown in FIG. 6, one or more teeth 16 feature widened ends 19 that project in a different way from the two opposing sides of each tooth, giving the teeth 16 an asymmetrical shape.

In particular, as shown in FIG. 6, some teeth 16 have a widened end 19 that projects from one side of the tooth only, while other teeth 16 have corresponding widened ends 19 that project from both sides of the tooth, even if with different lengths on the two sides.

The above mentioned asymmetry of the teeth 16 makes it possible to arrange the first projections 4, 4′ so that they are equally spaced from one another along the circumferential direction, at the same time maintaining the possibility to interpose the first projections 4, 4′ between the teeth 16 of the second modular element 15′, as is clearly visible in FIG. 6,

The equal distance between the first projections 4, 4′ advantageously makes it possible to superimpose the modular elements 15 on one another, in mutually staggered positions and facing any side, as described for the previous embodiment, while maintaining the continuity of the fins 11 of the stator core 18.

The modular element 15 preferably has a symmetrical shape with respect to an axis of symmetry Z passing through the centre X1.

Said symmetry makes it possible to obtain recesses 18a with a symmetrical plan, notwithstanding the asymmetry of the teeth 16 of the individual modular elements 15.

In fact, as shown in FIG. 8, when several symmetrical modular element 15 of the type described above are superimposed, mutually staggered by an angle equal to half their angular width α, the projections of the respective teeth 16 are alternately arranged on one side and on the other of each recess 18a.

In particular, each open area 18b of the recesses 18a is asymmetrical, too, with the advantage of making it easier for the insulating foils to be accommodated inside the recesses 18a.

In practice, for the assembly of the stator core 8 with the modular elements 1, 1′, the latter are sheared in succession from a strip 12 in a ferromagnetic material, as described above and illustrated in FIG. 2.

In particular, the shearing of two successive modular elements 1 and 1′ is carried out in such a way that each one of the first projections 4, 4′ of the first modular element 1 is interposed between a corresponding pair of teeth 3 of the second modular element 1′.

Preferably, the second modular element 1′ is sheared in a position that, with respect to the first modular element 1, is shifted along the direction of development of the strip 12 by such a distance that the teeth 3 of the second modular element 1′ are arranged so that they intersect the circumference whose centre is X1 and are tangential to the top of the first projections 4, 4′ of the first modular element 1.

The laminations obtained in this way, arranged side by side so as to form an annular lamination 6, are stacked on a previous annular layer in a position

that, compared to said previous annular layer, is rotated by an angle α corresponding to the angular interval described above, as shown in FIG. 3.

Once the laminations 6 have been stacked, they are welded to the connection bodies 10 that are preferably bars in a metallic material arranged against the external surface of the stator core 8, parallel to its longitudinal axis X, at the level of the recesses defined by the second projections 5, 5.

Before the connection bodies 10 are welded to the laminations 6, the stator core 8 is preferably compressed at the sides by means of tie rods, not illustrated herein but known per se, that compress the stator core 8 at the sides by means of corresponding annular bodies 14 shown in FIG. 4.

A self-bearing stator core 8 provided with cooling fins 11 is thus obtained,

Clearly, the operations described above are suited to make also the stator core 18 using modular elements 15 according to the variant embodiment described above.

The above dearly shows that the modular elements described above achieve all the objects of the invention.

In fact, the above mentioned modular elements make it possible to provide a self-bearing stator core provided with cooling fins, which therefore does not require any additional finned casing.

Consequently, the above mentioned stator core makes it possible to obtain a power generator or an electrical machine weighing less than electrical machines of the known type.

Therefore, said stator core is particularly suited to be used in is applications for the generation of wind or hydro power, where the weight considerably affects installation and maintenance costs.

Furthermore, the configuration of the modular element that is the subject of the invention is such that it allows any waste of the material used for making it to be minimized.

Upon implementation, the modular element and the stator core that are the subjects of the invention may be subjected to further changes that, even if not described herein and not illustrated in the drawings, must all be considered protected by the present patent, provided that they fall within the scope of the following claims.

Where technical features mentioned in any claim are followed by reference signs, those reference signs have been included for the sole purpose of increasing the intelligibility of the claims and accordingly such reference signs do not have any limiting effect on the protection of each element identified by way of example by such reference signs.

I claim:

1) Modular element for a stator core, comprising a plate-like body in a ferromagnetic material provided with:
a peripheral portion extending for an angular width of less than 360° over an arc of a circle having a centre;
a plurality of teeth projecting from said peripheral portion towards said centre;
a plurality of first projections extending from said peripheral portion on the opposite side with respect to said teeth according to corresponding directions of development;
wherein said first projections are configured so that each one of them can be interposed between two corresponding adjacent teeth of a second modular element that is identical to the first one and arranged so that it is coplanar with it,

2) Modular element according to claim 1), wherein each one of said first projections is spaced from each first projection adjacent to it by a distance that cannot be shorter than the width of the end of a corresponding one of said teeth.

3) Modular element according to claim 1), wherein the direction of development of each one of said first projections passes through said centre.

4) Modular element according to claim 1), wherein the width of said first projections gradually decreases along said direction of development as the distance from said centre increases.

5) Modular element according to claim 1), wherein the first projections of said plate-like body belonging to a first angular portion develop along said arc of a circle with a profile that is identical to the profile of the first projections belonging to a second angular portion of said plate-like body that, compared to said first angular portion, is shifted by a predefined angular interval along said arc of a circle.

6) Modular element according to claim 1), wherein said plate-like body is symmetrical with respect to an axis of symmetry passing through said centre and wherein at least a first one of said teeth comprises a widened end projecting from at least one side of said tooth in a direction orthogonal to the radial direction defined by said centre over a length that exceeds the length by which said widened end projects from the opposite side of said tooth.

7) Stator core comprising a plurality of laminations arranged so that they are stacked according to a direction parallel to a longitudinal axis, wherein each one of said laminations comprises at least one modular element to according to claim 1).

8) Stator core according to claim 7), wherein each one of said laminations comprises a plurality of modular elements, each one of which features an angular width equal to an integer submultiple of 360°, arranged adjacent to one another so as to form a ring.

9) Stator core according to claim 8), wherein it comprises at least two said modular elements, mutually staggered by an angle equal to said predefined angular interval around said longitudinal axis, wherein the first projections of said plate-like body belonging to a first angular portion develop along said arc of a circle with a profile that is identical to the profile of the first projections belonging to a second angular portion of said plate-like body that, compared to said first angular portion, is shifted by a predefined angular interval along said arc of a circle.

10) Stator core according to claim 8), wherein it comprises at least two said modular elements, mutually staggered by an angle equal to half said angular width around said longitudinal axis, wherein said plate-like body is symmetrical with respect to an axis of symmetry passing through said centre and wherein at least a first one of said teeth comprises a widened end projecting from at least one side of said tooth in a direction orthogonal to the radial direction defined by said centre over a length that exceeds the length by which said widened end projects from the opposite side of said tooth.

11) Stator core according to claim 7), wherein said laminations are rigidly connected to one another through joining means.

12) Stator core according to claim 11), wherein said joining means comprise at least one connection body welded to a plurality of said laminations.

13) Stator core according to claim 12), wherein said joining means comprise at least two second projections belonging to each one of said modular elements and projecting from the corresponding peripheral portion so as to delimit a corresponding recess whose profile matches the profile of the cross section of said connection body.

14) Stator core according to claim 13), wherein said second projections are shorter than said first projections.

15) Method for making two modular elements according to claim 1), comprising the operation of shearing said modular elements from said strip, wherein said two modular elements are sheared so that each one of the first projections of a first one of said modular elements is interposed between a corresponding pair of teeth of the second modular element.
